(19) United States
(12) Patent Application Publication
(10) Pub. No.: US 2024/0386343 A1
(43) Pub. Date: Nov. 21, 2024

(54) CHARACTER TRAITS ESTIMATION SYSTEM AND METHOD

(71) Applicant: Hitachi, Ltd., Tokyo (JP)

(72) Inventors: Toshiteru NAKAMURA, Tokyo (JP); Takashi NUMATA, Tokyo (JP); Yuya OGI, Tokyo (JP)

(21) Appl. No.: 18/436,099

(22) Filed: Feb. 8, 2024

(30) Foreign Application Priority Data
May 16, 2023 (JP) 2023-080980

(51) Int. Cl. G06Q 10/0631; G06Q 10/1053; G06T 7/70

(52) U.S. Cl. CPC G06Q 10/063112; G06Q 10/1053; G06T 7/70; G06T 2207/30196

(57) ABSTRACT

A system provides, to a subject apparatus including one or a plurality of sensors, inducement information for inducing a subject to take an action for a purpose different from psychological characteristics estimation. The system receives measurement data relating to the action taken by being induced by the inducement information, the measurement data being based on measurement by the one or the plurality of sensors. The action induced by the inducement information includes designation of subject intention and a related action that is all or a part of actions excluding the designation of the subject intention. The system calculates one or a plurality of action feature values based on the related action data in the measurement data and estimates psychological characteristics of the subject based on the action feature values.

### CROSS-REFERENCE TO PRIOR APPLICATION

This application relates to and claims the benefit of priority from Japanese Patent Application number 2023-080980, filed on May 16, 2023 the entire disclosure of which is incorporated herein by reference.

### BACKGROUND

The present invention generally relates to a technique for estimating character traits.

As an example of character traits, there are psychological characteristics (personality). As a technique for estimating psychological characteristics, for example, a technique disclosed in Patent Literature 1 is known. The technique disclosed in Patent Literature 1 estimates psychological characteristics of a user based on text data in addition to utterance data of the user.

Note that, as a technique for estimating a psychological state of a person, a technique disclosed in Patent Literature 2 is known. The technique disclosed in Patent Literature 2 estimates a psychological state of a user based on vital data of the user.
Patent Literature 1: U.S. Pat. No. 10,957,306
Patent Literature 2: Japanese Patent Application Laid-Open No. 2022-179438

### SUMMARY

In the technique disclosed in Patent Literature 1, a subject has to take another action such as utterance for psychological characteristics estimation besides answering questions prepared for a purpose different from the psychological characteristics estimation. The subject does not always take such another action. Therefore, psychological characteristics are not always estimated for the subject. A problem in that it takes a lot of time for creating text data to be input is also conceivable.

In the technique disclosed in Patent Literature 2, although a temporary psychological state is estimated, psychological characteristics specific to a person cannot be estimated.

A system provides, to a subject apparatus that is an apparatus including one or a plurality of sensors, provision information including inducement information for inducing a subject to take an action for a purpose different from psychological characteristics estimation. The system receives, from the subject apparatus, measurement data relating to the action taken by the subject being induced by the provided inducement information, the measurement data being based on measurement by the one or the plurality of sensors, and specifies subject intention data and related action data based on the measurement data. The action induced by the inducement information includes designation of subject intention and a related action that is all or a part of actions excluding the designation of the subject intention. The subject intention data is data representing the designated subject intention. The related action data is data representing the related action. The system calculates one or a plurality of action feature values based on the related action data for each of the one or the plurality of related actions, estimates psychological characteristics of the subject based on the one or the plurality of action feature values, and outputs data representing the estimated psychological characteristics. Each of one or more action feature values used to estimate the psychological characteristics of the subject is adjusted information on at least a part of the provided provision information and/or the action feature value enhanced according to an elapsed time.

According to the present invention, it is possible to estimate psychological characteristics of a subject without the subject taking a dedicated action for estimating the psychological characteristics.

### BRIEF DESCRIPTION OF THE DRAWINGS

FIG. 1 illustrates a configuration example of an entire system according to a first embodiment;

FIG. 2 illustrates data and functions in the entire system according to the first embodiment;

FIG. 3 illustrates an example of a flow of processing performed in the first embodiment;

FIG. 4A illustrates an example of a position of a person in a camera frame;

FIG. 4B illustrates an example of a position of a person in the camera frame;

FIG. 4C illustrates an example of a position of a person in the camera frame;

FIG. 5 illustrates an example of a relation among a feature value category, an action feature value, and a related action value;

FIG. 6A illustrates an example of a screen having first background luminance;

FIG. 6B illustrates an example of a screen having second background luminance;

FIG. 7 illustrates data and functions in an entire system according to a second embodiment;

FIG. 8 illustrates data and functions in an entire system according to a third embodiment;

FIG. 9 illustrates an example of a keyword table according to a fourth embodiment; and

FIG. 10 illustrates an example of a practical application of a character traits estimation system according to the first to fourth embodiments.

### DESCRIPTION OF EMBODIMENTS

In the following explanation, an “interface apparatus” may be one or more interface devices. The one or more interface devices may be at least one of the following.
An I/O (Input/Output) interface apparatus that is one or more I/O interfaces. The I/O (Input/Output) interface device is an interface device for at least one of an I/O device and a remote computer for display. The I/O interface device for the computer for display may be a communication interface device. The at least one I/O device may be a user interface device, for example, either an input device such as a keyboard and a pointing device or an output device such as a display device.
A communication interface apparatus that is one or more communication interface devices. The one or more communication interface devices may be one or more communication interface devices of the same type (for example, one or more NICs (Network Interface Cards)) or may be two or more communication interface devices of different types (for example, an NIC and an HBA (Host Bus Adapter)).

In the following explanation, a “memory” is one or more memory devices, which are examples of one or more storage devices, and may be typically a main storage device. At least one memory device in the memory may be a volatile memory device or may be a nonvolatile memory device.

In the following explanation, a “permanent storage apparatus” may be one or more permanent storage devices, which are examples of one or more storage devices. The permanent storage device may be typically a nonvolatile storage device (for example, an auxiliary storage device) and may be specifically, for example, an HDD (Hard Disk Drive), an SSD (Solid State Drive), an NVME (Non-Volatile Memory Express) drive, or an SCM (Storage Class Memory). In the following explanation, a “storage apparatus” may be at least the memory of the memory and the permanent storage device.

In the following explanation, a “processor” may be one or more processor devices. At least one processor device may be typically a microprocessor device such as a CPU (Central Processing Unit) but may be another type of processor device such as a GPU (Graphics Processing Unit). The at least one processor device may be a single core or may be a multicore. The at least one processor device may be a processor core. The at least one processor device may be a processor device in a broad sense such as a circuit (for example, an FPGA (Field-Programmable Gate Array), a CPLD (Complex Programmable Logic Device), or an ASIC (Application Specific Integrated Circuit)), which is an aggregate of gate arrays, described by a hardware description language, that performs a part or all of processing.

In the following explanation, a function is sometimes explained with an expression of “yyy unit”. However, the function may be implemented by one or more computer programs being executed by a processor, may be implemented by one or more hardware circuits (for example, FPGAs or ASICs), or may be implemented by a combination of the hardware circuits. When the function is implemented by a program being executed by the processor, since decided processing is performed while using a storage apparatus, an interface apparatus, and/or the like, the function may be at least a part of the processor. The processing explained using the function as a subject may be processing performed by the processor or an apparatus including the processor. The program may be installed from a program source. The program source may be, for example, a storage medium (for example, a non-transitory storage medium) readable by a program distributing computer or a computer. Explanation of functions is an example. A plurality of functions may be integrated into one function, or one function may be divided into a plurality of functions.

In the following explanation, when elements of the same type are explained without being distinguished, a common sign is used among reference signs. When the elements of the same type are distinguished, the reference signs are sometimes used.

Several embodiments are explained below. Note that, in the following embodiments, psychological characteristics are adopted as an example of character traits and the psychological characteristics are estimated.

### First Embodiment

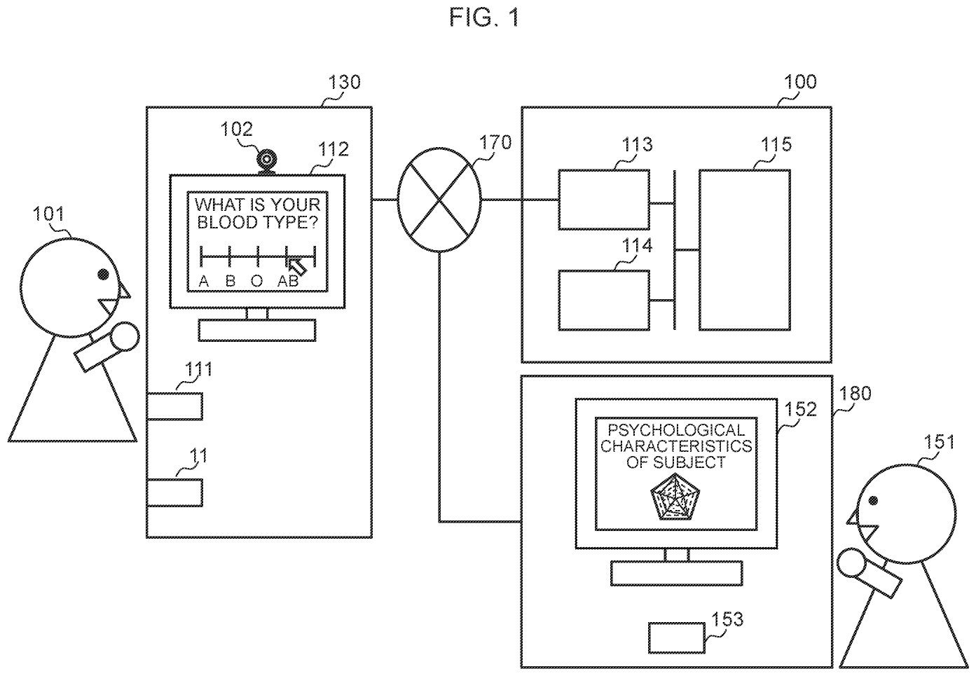

FIG. 1 illustrates a configuration example of an entire system according to a first embodiment.

A character traits estimation system 100 communicates with a subject apparatus 130 and an administrator apparatus 180 via a communication network 170. The communication network 170 is, for example, the Internet, a WAN (Wide Area Network), or a LAN (Local Area Network).

The subject apparatus 130 is an information processing terminal, for example, a computer such as a personal computer or a smartphone of a subject 101. The subject apparatus 130 includes one or a plurality of sensors that measure an action of the subject 101 and a display device 112. The one or the plurality of sensors are, for example, a camera 102, an input device 111 (for example, a keyboard and a pointing device), and a microphone 11. The display device 112 may be a touch panel instead of or in addition to the input device 111. The subject 101 may be, for example, an applicant in an online interview.

The administrator apparatus 180 is an information processing terminal, for example, a computer such as a personal computer or a smartphone of an administrator 151. The administrator apparatus 180 includes an input device 153 and a display device 152. The administrator 151 may be, for example, an interviewer in the online interview.

The character traits estimation system 100 includes an interface apparatus 113, a storage apparatus 114, and an arithmetic apparatus 115 coupled to the interface apparatus 113 and the storage apparatus 114.

The interface apparatus 113 communicates with the subject apparatus 130 and the administrator apparatus 180 via the communication network 170. The storage apparatus 114 stores a computer program to be executed by the arithmetic apparatus 115 and data input and output by the arithmetic apparatus 115. The arithmetic apparatus 115 is a processor and executes the computer program.

The arithmetic apparatus 115 provides, to the subject apparatus 130, provision information that is information including inducement information for inducing the subject 101 to take an action for a purpose different from psychological characteristics estimation. The inducement information may include a plurality of questions (or one question). Specifically, the inducement information may include, for example, a plurality of questions (or one question) provided as voice and/or text by executing an AI (Artificial Intelligence) serving as an interviewer or another program and content serving as a virtual robot such as an avatar that provides the questions. The content may include text and another type of information (for example, figures) representing the questions. The “questions” provided in this embodiment may be general questions in the interview and may not include questions prepared for the psychological characteristics estimation.

The arithmetic apparatus 115 receives, from the one or the plurality of sensors, through the interface apparatus 113, measurement data relating to the action taken by the subject 101 being induced by the inducement information of the provision information, the measurement data being based on measurement by the one or the plurality of sensors.

The arithmetic apparatus 115 specifies subject intention data and related action data based on the measurement data. The “action included by the inducement information” includes designation of subject intention and a related action that is all or a part of actions excluding the designation of the subject intention. The designation of the subject intention is answer to a question (for example, type input or voice input of the answer to the question) in this embodiment. However, the designation of the subject intention may be various depending on information to be provided. In this embodiment, the related action is all or a part of actions until answering the question after the question is provided. However, the related action may be various depending on the designation of the subject intention that depends on the provided information. The subject intention data is data representing the designated subject intention. The related action data is data representing the related action.

The arithmetic apparatus 115 calculates one or a plurality of action feature values based on related action data for each of one or a plurality of related actions and estimates psychological characteristics of the subject 101 based on the one or the plurality of action feature values. Specifically, for example, every time a question is displayed, the displayed question is answered by the subject 101. There is a related action for each set of the question and the answer. There is related action data for each of the plurality of related actions. The arithmetic apparatus 115 calculates one or a plurality of action feature values based on the related action data of the plurality of related actions and estimates psychological characteristics of the subject 101 based on the one or the plurality of action feature values.

The arithmetic apparatus 115 outputs estimated psychological characteristics data that is data representing the estimated psychological characteristics. For example, the arithmetic apparatus 115 transmits the estimated psychological characteristics data to the administrator apparatus 180. The administrator apparatus 180 displays, on the display device 152, the psychological characteristics represented by the estimated psychological characteristics data. Consequently, the administrator 151 learns the estimated psychological characteristics of the subject 101.

Each of one or more action feature values used to estimate psychological characteristics of the subject 101 is adjusted information of at least a part of the provided provision information and/or the action feature value enhanced according to an elapsed time (an example of the enhancement is explained in detail below).

According to this embodiment, it is possible to estimate psychological characteristics of the subject 101 without the subject 101 taking an action different from an action (for example, an answer to a question) induced by inducement information prepared and provided for a purpose different from the psychological characteristics estimation, that is, without the subject 101 taking a dedicated action for estimating psychological characteristics. According to this embodiment, since the one or more action feature values used to estimate psychological characteristics of the subject 101 is enhanced, improvement of psychological characteristics estimation accuracy is expected.

Note that the character traits estimation system 100 may be a physical computer system (one or more physical computers) exemplified in FIG. 1 but may be, instead of the physical computer system, a logical computer system (for example, a cloud computing system) based on the physical computer system.

The “psychological characteristics” may be composed of one or more psychological characteristics components. The one or more psychological characteristics components may include at least one of a temperament, a character, a personality, a belief, a value, a mood, and an emotion. The arithmetic apparatus 115 may estimate psychological characteristics based on a part of subject intention data. The arithmetic apparatus 115 may estimate, based on subject intention data (for example, answer data including a name and sex) in addition to the estimated psychological characteristics data, character traits (including, for example, besides the psychological characteristics, at least one of a name, sex, a date of birth, an age, a motivation, a desired job title, a background, performance, and possessed skills).

The “related action” may be an action leading to an answer to a question (an example of designation of a subject intention). For example, even if the answer is the same, the action leading to the answer is affected by the psychological characteristics of the subject 101. Since the related action data representing such an action is used for the psychological characteristics estimation, even if a question and a subject action dedicated to the psychological characteristics estimation are absent, it is expected that the psychological characteristics are accurately estimated.

This embodiment is explained in detail below.

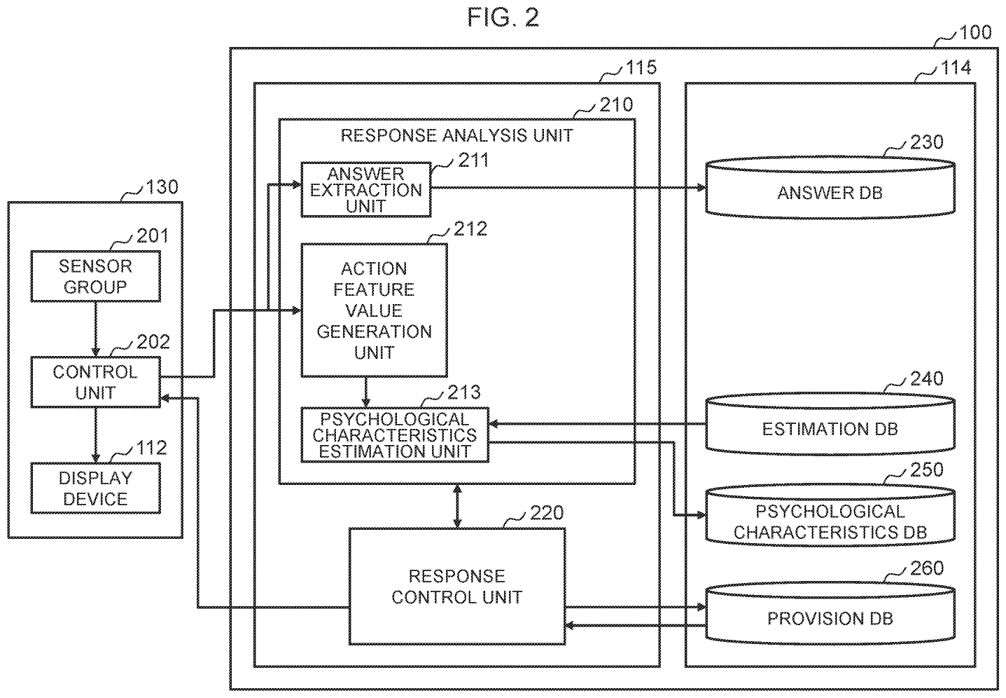

FIG. 2 illustrates data and functions in the entire system according to the first embodiment. Note that, in this embodiment, “DB” is an abbreviation of database. The data may not be structured data like the database.

The subject apparatus 130 includes, as explained above, a sensor group 201 (the one or the plurality of sensors) and the display device 112 and includes a control unit 202. The control unit 202 is implemented by a program (for example, an application program) being executed by an arithmetic apparatus (not illustrated), which is a processor of the subject apparatus 130.

The control unit 202 transmits measurement data based on measurement of the sensors in the sensor group 201 to the character traits estimation system 100. The control unit 202 outputs, to the display device 112 and/or another output device (for example, a loudspeaker), provision information provided from the character traits estimation system 100.

The storage apparatus 114 stores an answer DB 230, an estimation DB 240, a psychological characteristics DB 250, and a provision DB 260. The answer DB 230 is a DB in which answer data (data representing an answer to a question) is stored. The estimation DB 240 is a DB in which data used to estimate psychological characteristics (for example, one or a plurality of models such as regression formulas) is stored. The psychological characteristics DB 250 is a DB in which estimated psychological characteristics data (data representing an estimated psychological characteristics) is stored. The provision DB 260 is a DB in which information to be provided (for example, content itself such as a question) and information concerning the information (for example, metadata such as luminance of the content) is stored.

The arithmetic apparatus 115 executes a computer program, whereby a response analysis unit 210 that performs an analysis of a response from the subject 101 and a response control unit 220 that controls a response to the subject 101 are implemented. The response analysis unit 210 includes an answer extraction unit 211 that extracts an answer, an action feature value generation unit 212 that generates an action feature value, and a psychological characteristics estimation unit 213 that estimates psychological characteristics.

Examples of functions implemented by the arithmetic apparatus 115 and processing performed in this embodiment are explained below.

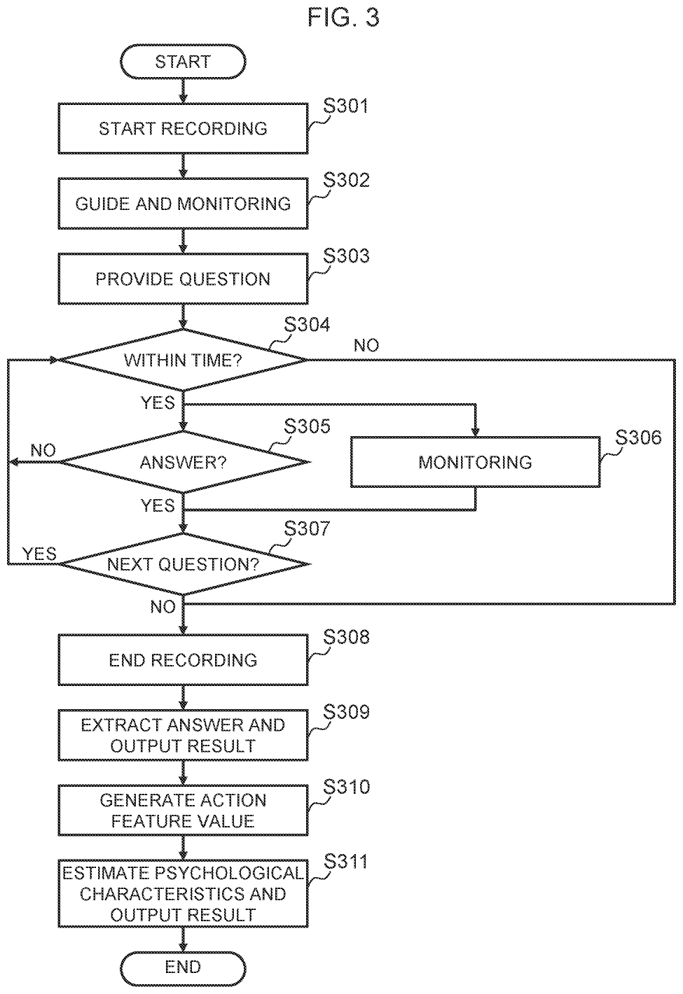

FIG. 3 illustrates an example of a flow of the processing performed in the first embodiment.

The response analysis unit 210 receives, from the control unit 202 of the subject apparatus 130, data of a moving image captured by the camera 102 in the sensor group 201. The response analysis unit 210 starts recording of the moving image (S301). Recording data (moving image data) may be at least a part of measurement data and is stored in the storage apparatus 114 by the response analysis unit 210. The response control unit 220 may transmit notification of the recording start to the control unit 202 of the subject apparatus 130. The control unit 202 may output the notification through the display device 112 or another output device.

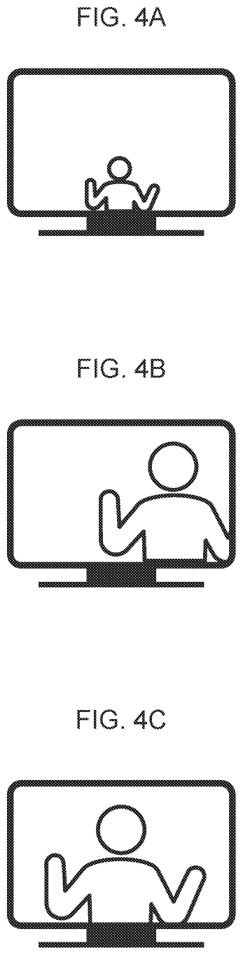

The response control unit 220 guides the subject 101 and the response analysis unit 210 monitors the guided subject 101 (S302). Specifically, inducement information transmitted to the subject apparatus 130 by the response control unit 220 includes information representing the guide for the subject 101. The guide may be a guide contributing to enhancement of an action feature value. For example, when the response analysis unit 210 determines from the recording data that the position of the subject 101 is inappropriate with respect to an angle of view (a frame) of the camera 102 (or irrespective of whether the position is appropriate), the response control unit 220 may transmit, to the subject apparatus 130, inducement information including information representing a guide for superimposing the position of the subject 101 on a position appropriate with respect to the angle of view (the frame) of the camera 102. Consequently, for example, the subject 101 present in an inappropriate position (an inappropriate position in the camera frame) exemplified in FIGS. 4A and 4B is moved to an appropriate position exemplified in FIG. 4C. Accordingly, thereafter, improvement of accuracy of an action feature value to be generated is expected. Therefore, improvement of psychological characteristics estimation accuracy is expected.

The guide may include, instead of or in addition to the guide to the position with respect to the angle of view of the camera 102, another guide contributing to the enhancement of the action feature value, for example, a guide for increasing a probability of accurately detecting utterance of the subject 101 (for example, a guide for adjusting microphone setting or a guide for adjusting the distance between the microphone and the subject 101).

In the monitoring, the response analysis unit 210 specifies, from the recording data, an action (an example of a related action) of the subject 101 for the inducement information including the information representing such a guide. The action feature value generation unit 212 generates an action feature value concerning the action. The generated action feature value may be stored in the storage apparatus 114.

Note that the action feature value extracted from the action (in particular, the related action) of the subject 101 does not need to be limited to one. Psychological characteristics can be estimated by integrating a variety of action feature values. For example, related action data specified by the action feature value generation unit 212 based on the recording data may be data representing at least one of a head motion (a motion of the head of the subject 101), a facial expression (a facial expression of the subject 101), an eyeball motion (an eyeball motion of the subject 101), a posture (a posture of the subject 101), a body motion (a body motion of the subject 101), sound (sound of utterance of the subject 101), a vital sign (a vital sign of the subject 101), a time (a time required for a response by the subject 101), and apparatus operation (operation of the subject apparatus 130 by the subject 101). The action feature value generation unit 212 may generate an action feature value from such related action data. Consequently, it is possible to estimate psychological characteristics of the subject 101 from at least one viewpoint among various viewpoints.

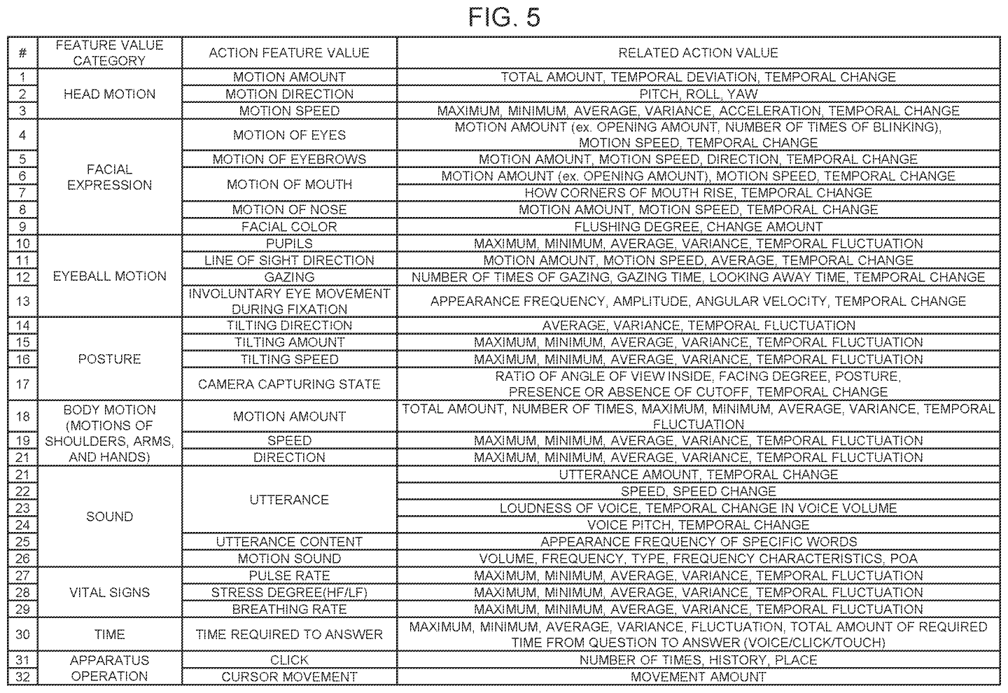

An example of a relation among feature value categories (the head motion, the facial expression, the eyeball motion, the posture, the body motion, the sound, the vital sign, the time, and the apparatus operation), the action feature value, and the related action value is as illustrated in FIG. 5. The “related action value” is a value specified from the related action data (a value representing the related action). For example, there is related action data concerning the head motion as the related action data specified from the recording data. Related action values such as a maximum value and a minimum value of the speed of the head of the subject 101 are obtained from a time sequence of such related action data. For each of the feature value categories, there is one or a plurality of action feature values. For each of the action feature values, there is one or a plurality of related action values serving as elements for calculating the action feature values. The action feature value generation unit 212 can generate an action feature value with a predetermined generation model (for example, a regression formula or another model) in which the one or the plurality of related action values are used. For each of the action feature values, a generation model for generating the action feature value may be different. The generation model for each of the action feature values may be stored in the storage apparatus 114 (for example, the estimation DB 240) and specified from the storage apparatus 114.

After the guide and the monitoring explained above (after S302), the response control unit 220 specifies one or a plurality of questions to be provided from the provision DB 260 and provides provision information including information representing the specified one or plurality of questions to the subject apparatus 130 (S303). The questions may be provided at a time or may be sequentially provided (the next question may be provided every time an answer is received).

The response analysis unit 210 may set a limit time for an answer to the provided one or plurality of questions and notify the limit time to the subject 101. For example, the limit time for an answer may not always be set. However, when the limit time is correlated with the provided one or plurality of questions in the provision DB 260, the response analysis unit 210 may set the limit time.

For example, the response analysis unit 210 determines whether an answer has been received within the limit time (S304). If an answer has been received within the limit time (S304: YES, S305: YES), the answer extraction unit 211 of the response analysis unit 210 extracts an answer from measurement data received from the subject apparatus 130 (data including data representing an answer input through the input device 111) and stores data representing the extracted answer in the storage apparatus 114. In parallel, the action feature value generation unit 212 specifies related action data from the measurement data and stores the specified related action data in the storage apparatus 114 (S306).

If there is a next question (S307: YES), the processing returns to S304. When all questions are answered and the next question is absent (S307: NO) or when the limit time ends (S304: NO), the response analysis unit 210 ends the recording (S308). The response control unit 220 may transmit notification of the recording end to the control unit 202 of the subject apparatus 130. The control unit 202 may output the notification through the display device 112 or another output device.

The answer extraction unit 211 acquires the answer data stored in the storage apparatus 114 and outputs the acquired answer data to (stores the acquired answer data in) the answer DB 230 (S309). The answer extraction unit 211 may output the acquired answer data to the administrator apparatus 180.

The action feature value generation unit 212 calculates a related action value for each of the related actions from the related action data for each of the related actions accumulated in the storage apparatus 114 and generates a plurality of action feature values (or one action feature value) using a calculated plurality of related action values (or one related action value) (S310).

The psychological characteristics estimation unit 213 estimates psychological characteristics of the subject 101 based on the generated plurality of action feature values (or one action feature value) using a model represented by the estimation DB 240 and outputs estimated psychological characteristics data to (stores estimated psychological characteristics data in) the psychological characteristics DB 250 (S311). The psychological characteristics estimation unit 213 outputs the estimated psychological characteristics data to the administrator apparatus 180 in S311 or after S311.

Instead of the answer data (an example of the subject intention data) and the estimated psychological characteristics data being output at separate timings, integrated data of those data may be output. An output destination of the answer data and an output destination of the estimated psychological characteristics data may be the same or may be different. The estimated psychological characteristics data may be output to the subject apparatus 130 instead of or in addition to the administrator apparatus 180. Consequently, the subject 101 can learn the estimated psychological characteristics of the subject 101 by answering the question.

In the processing explained with reference to FIG. 3, the measurement data from the subject apparatus 130 includes the moving image data representing the moving image of the subject 101 captured by the camera 102. The action feature value generation unit 212 specifies, based on the moving image data (the recording data), the related action data for each of the one or the plurality of related actions. Since various related action data can be acquired from the moving image data, improvement of psychological characteristics estimation accuracy is expected.

In the processing explained with reference to FIG. 3, the response control unit 220 may notify the limit time for an answer to the one or the plurality of questions to the subject 101. In general, in an interview or a survey, the administrator 151 (for example, an interviewer, an examiner, or an instructor) can perform time adjustment while viewing a status of the subject 101 and guide the subject 101 such that a survey of character traits are completed within a set time. However, in an automated interview or survey, the administrator 151 is absent (a party that the subject 101 talks to is a computer and is not the administrator 151). For this reason, the interview or the survey is practically conducted after a time limit is provided for a question and a response. A difference in sensitivity due to characteristics to such a time limit appears as an action feature value that is a value different concerning the characteristics. As a result, improvement of psychological characteristics estimation accuracy is expected.

In the processing explained with reference to FIG. 3, each of the one or more action feature values used to estimate psychological characteristics of the subject 101 is adjusted information on at least a part of the provided provision information and/or the action feature value enhanced according to an elapsed time. For example, the provision of the guide explained above contributes to the enhancement of the action feature value. This is because generation of a more accurate action feature value is expected. The “enhancement” of the action feature value may include a meaning of either increasing or reducing the action feature value.

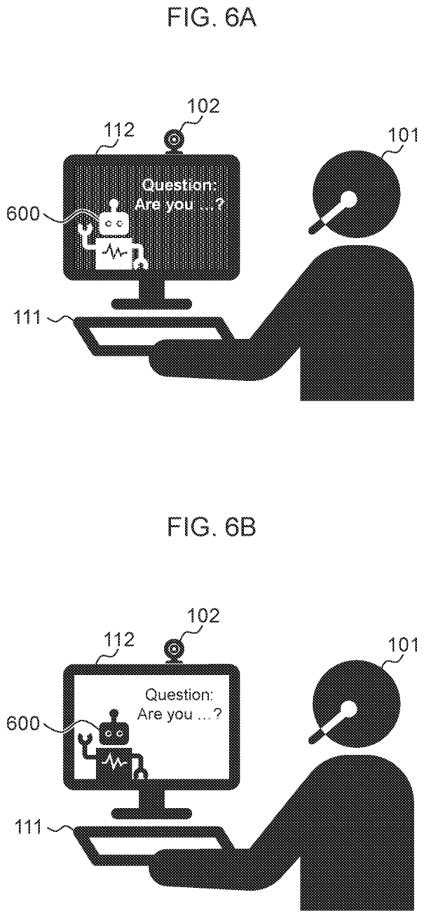

As another example of the enhancement of the action feature value, the next example may be adopted. That is, as the related action data, there is vital data specified, for the subject 101 appearing in a moving image represented by moving image data, from the moving image. The adjusted information on at least a part of the provision information is information in which both of luminance of content displayed on the subject apparatus 130 and luminance of a background of the content are adjusted. Such information may be displayed at any timing from a start to an end of recording (for example, in at least one of S302 and S303). The action feature value generation unit 212 estimates vital data from the face of the subject 101 represented by the moving image data. For example, vital data representing a very small color change of a facial surface changed by a blood flow is estimated. In order to improve an S/N ratio and improve vital data estimation accuracy, in other words, to enhance the action feature value based on the vital data, it is desirable that the face is sufficiently illuminated. Therefore, the display device 112 of the subject apparatus 130 is utilized as illumination for lighting the face of the subject 101. The information in which both of the luminance of the content and the luminance of the background of the content are adjusted may be prepared in the provision DB 260 in advance or may be dynamically adjusted by the response control unit 220. When the area of a background is larger than the area of content (for example, text of a question or an avatar that provides the question) on an entire screen, background luminance is higher than content luminance in information (screen information) including the content and the background. That is, in such a case, display on the display device 112 is not display exemplified in FIG. 6A but is display exemplified in FIG. 6B. On the other hand, when the area of a background is smaller than the area of content on an entire screen, background luminance is lower than content luminance in information (screen information) including the content and the background. Note that, in general, a color change of a region from red to green is extracted to estimate a vital sign. Therefore, a wavelength region of red to green may be adopted for one having higher luminance (brighter one) of the background and the content.

As still another example of the enhancement of the action feature value, the following example may be adopted.

That is, for example, in S311, the psychological characteristics estimation unit 213 may enhance, concerning each of one or more action feature values, the action feature value according to an elapsed time. The psychological characteristics estimation unit 213 may estimate psychological characteristics of the subject 101 based on one or a plurality of action feature values including the one or more action feature values respectively enhanced. In an interview or a survey, characteristics of actions of the subject 101 sometimes change (for example, voice gradually becomes quieter or louder, the speed of convergence of a breathing rate and a vital sign changes, gestures increase or decrease, and a facial expression changes) because, for example, the subject 101 is accustomed to an atmosphere of the interview or the survey. Therefore, by using, for psychological characteristics estimation, an action feature value enhanced according to elapse of time (for example, an adaption degree corresponding to an elapsed time) (by considering a change of the action feature value in the elapsed time), improvement of psychological characteristics estimation accuracy is expected. An appearance degree of a motion feature value with respect to a limit time can also be reflected on psychological characteristics estimation. Therefore, improvement of psychological characteristics estimation accuracy is expected. In this paragraph, a part or all of “one or a plurality of action feature values” may be enhanced action feature values. In other words, in “one or a plurality of action feature values”, enhanced action feature values and un-enhanced action feature values may be mixed.

As an estimation model stored in the estimation DB 240, at least one of first to third estimation models described below (1) to (3) may be stored. All the estimation models are multiple regression models. However, the estimation model stored in the estimation DB 240 may be another model instead of or in addition to the at least one of the first to third models.

(1) First estimation model:

$$y = \int ( a ( t ) + {b}_{1} ( t ) {x}_{1} ( t ) + {b}_{2} ( t ) {x}_{2} ( t ) + {b}_{3} ( t ) {x}_{3} ( t ) + … + {b}_{n} ( t ) {x}_{n} ( t ) ) dt$$

(2) Second estimation model: y=a+b₁x₁+b₂x₂+b₃x₃+ . . . +bₙxₙ and bₚxₚ=f(cₚ₁[_{T1}]xₚ[_{T1}], cₚ₂[_{T2}]xₚ[_{T2}], . . . , cₚₘ[_{Tm}]xₚ[_{Tm}])
(3) Third estimation model: y=a+b₁x₁+b₂x₂+b₃s₃+ . . . +bₙxₙ

Note that variables of the estimation are as described below (1) to (9).

(1) y is a psychological characteristics component (an explained variable).
(2) a is a constant.
(3) bx is an explanatory variable.
(4) x (for example, each of x₁, x₂, . . . , and xₙ) is an action feature value.
(5) b (for example, each of b₁, b₂, . . . , and bₙ) and c (for example, each of cₚ₁, cₚ₂, . . . , and cₚₘ) are respectively weighting coefficients.
(6) n and m are respectively integers equal to or larger than 1. Both of n and m may be different depending on a psychological characteristics component. n may be different depending on a psychological characteristics component, for example, in a certain psychological characteristics component, n=5 and, in another psychological characteristics component, n=3. The same applies to m.
(7) t is an elapsed time.
(8) T (T1, T2, . . . , and Tm) is a time slot (an example of an elapsed time).
(9) p is any integer among 1 to n.

Each of the first to third models may be prepared for each of psychological characteristics components. The same estimation model may be used for all of a plurality of psychological characteristics components (a value substituted in the explanatory variable may be different depending on a psychological characteristics component), any one of the first to third models may be used depending on a certain psychological characteristics component, and another any one of the first to third estimation models may be used depending on another psychological characteristics component.

The psychological characteristics estimation unit 213 may estimate at least one psychological characteristics component using the first estimation model. The first estimation model includes a multiple regression model for each elapsed time. The multiple regression model for each elapsed time includes n explanatory variables (n is an integer equal to or larger than 1 and is a value corresponding to a psychological characteristics component corresponding to the multiple regression model) corresponding to n action feature values in a one-to-one relation and a weighting coefficient decided by the elapsed time for each of the n explanatory variables. With the first estimation model, it can be expected to estimate psychological characteristics from an entire interview time frame while always changing the weighting coefficient with respect to elapse of time, that is, psychological characteristics estimation with high accuracy can be expected. Note that, for example, for a certain motion feature value, a first elapsed time may be a first time range from an interview start to first time of day. For another motion feature value, a second elapsed time may be a second time range from k minutes after the interview start to second time of day. A time-of-day interval of the first elapsed time and a time-of-day interval of the second elapsed time may be continuous, may be discrete, or may overlap. For each of the elapsed times, a start and an end may be dynamically determined based on an action feature value or others. Since the elapsed times are typically dynamic, the lengths of the elapsed times and the number of the elapsed times may be different between when the first estimation model is used to estimate a certain psychological characteristics component and when the first estimation model is used to estimate another psychological characteristics component.

The psychological characteristics estimation unit 213 may estimate at least one psychological characteristics component using the second estimation model. The second estimation model includes n multiple regression models (n is an integer equal to or larger than 1) corresponding to n action feature values in a one-to-one relation. For each of the n multiple regression models, the multiple regression model includes m weighting coefficients corresponding to, in a one-to-one relation, m time slots (m is an integer equal to or larger than 2) forming a time (for example, an evaluation target time like an interview time) and an explanatory variable that is an action feature value corresponding to the multiple regression model for each of the m weighting coefficients. Consequently, it is possible to estimate psychological characteristics considering an elapsed time with less calculation resources compared with the first estimation model (with a small arithmetic load for the arithmetic apparatus 115). Note that, for example, for one psychological characteristics component, the lengths of the m time slots may be the same or may be different. The length of each of the m time slots may be common to all psychological characteristics components or may be different depending on a psychological characteristics component (in the latter case, the lengths of the time slots are desirably appropriate lengths depending on an action feature value serving as an explained variable). In estimating a certain psychological characteristics component using the second estimation model, a certain explanatory variable may be bₚxₚ=cₚ₁[_{T1}]xₚ[_{T1}]+cₚ₂[_{T2}]xₚ[_{T2}]+ . . . , +cₚₘ[_{Tm}]xₚ[_{Tm}] and another explanatory variable may be a different formula.

To estimate at least one psychological characteristics component for which an elapsed time is preferably considered, the psychological characteristics estimation unit 213 may select, based on a model selection policy (for, for example, which of an arithmetic load and estimation accuracy is prioritized) including a relation (typically, a magnitude relation) between an arithmetic load (for example, a processor use rate) of the arithmetic apparatus 115 and a threshold of the arithmetic load, which of the first estimation model and the second estimation model is used. For example, when the arithmetic load of the arithmetic apparatus 115 is smaller than the threshold, the psychological characteristics estimation unit 213 may select the first estimation model that requires more calculation resources but is expected to have high estimation accuracy and estimate a psychological characteristics component using the first estimation model. On the other hand, when the arithmetic load of the arithmetic apparatus 115 is equal to or larger than the threshold, the psychological characteristics estimation unit 213 may select the second estimation model requiring less calculation resources and estimate a psychological characteristics component using the second estimation model. In this way, it is possible to select an optimum estimation model according to an arithmetic status. Therefore, it is expected to carry out estimation corresponding to the arithmetic status.

The first embodiment is as explained above. Note that, in the first embodiment, at least one of the following (1) to (4) may be adopted.

(1) The action feature value generated based on the moving image data may be at least one of a motion of the eyes, a motion of the eyebrows, a motion of the mouth, a motion of the nose, and a change in a facial color.
(2) The action feature value generated based on the moving image data may be at least one of fluctuation of the pupils, fluctuation in a line of sight, a degree of gazing, and an involuntary eye movement during fixation.
(3) The action feature value generated based on the moving image data may be at least one of a motion of the head, a motion of the body, a motion of the shoulders, a motion of the arms, a motion of the hands, and a position of the subject 101 with respect to the angle of view of the camera 102.
(4) The action feature value generated based on the moving image data may be at least one of a pulse rate, a stress degree, and a breathing rate estimated from a change in a facial color between video frames in the moving image data.

### Second Embodiment

A second embodiment is explained. In the explanation, differences from the first embodiment are mainly explained. Explanation is omitted or simplified about similarities to the first embodiment (the same applies to third and fourth embodiments).

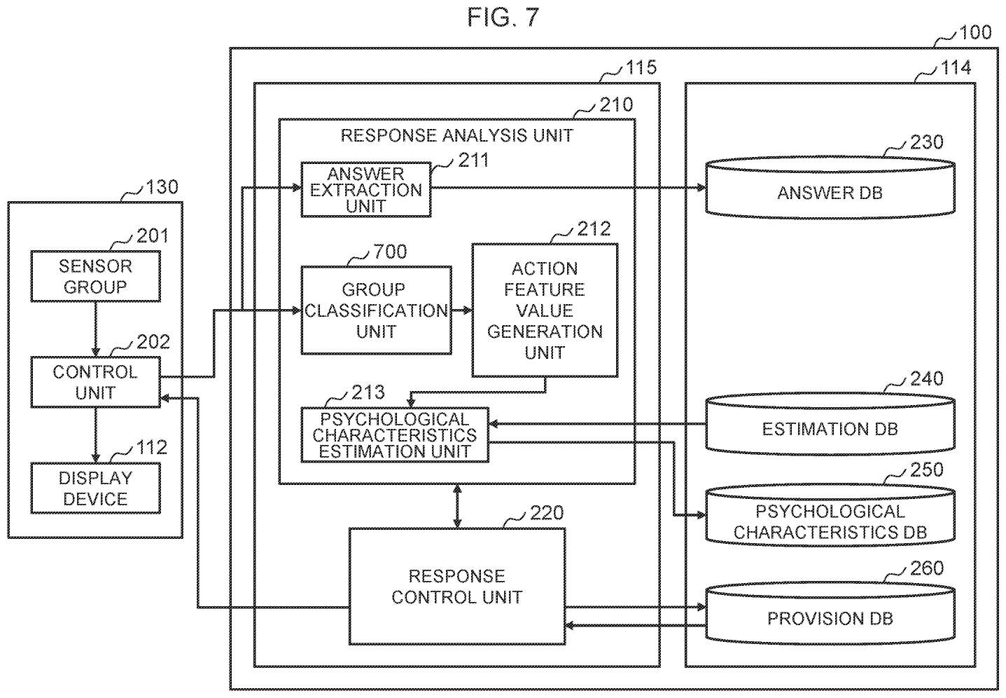

FIG. 7 illustrates data and functions in an entire system according to the second embodiment.

Each of a plurality of questions to the subject 101 may be classified into a group corresponding to an attribute of the question among a plurality of groups. Data representing a relation between the questions and the groups may be stored in the provision DB 260.

The response analysis unit 210 includes a group classification unit 700. For example, an estimation model may be stored in the estimation DB 240 for each of the groups.

The group classification unit 700 classifies, for each of the plurality of questions, related action data relating to an answer to the question into a group to which the question belongs. The action feature value generation unit 212 generates an action feature value for each of the plurality of groups based on related action data classified into the group. For example, the action feature value generation unit 212 may aggregate action related values (for example, calculate an average) for each of the groups and calculate an action feature value from the aggregated action related values. The psychological characteristics estimation unit 213 estimates psychological characteristics of the subject 101 based on the action feature value calculated for each of the plurality of groups. Consequently, it is expected to efficiently and accurately perform psychological characteristics estimation.

### Third Embodiment

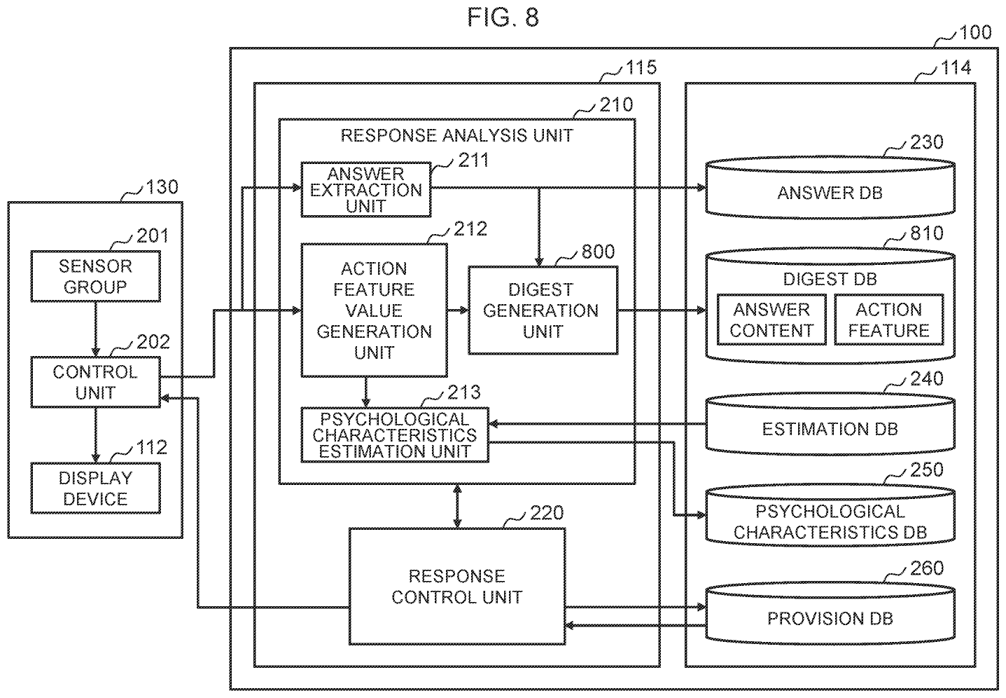

FIG. 8 illustrates data and functions in an entire system according to a third embodiment.

The response analysis unit 210 includes a digest generation unit 800. The storage apparatus 114 stores a digest DB 810 in which digest data is stored.

The digest generation unit 800 acquires an action digest moving image, which is a moving image in a time period related to a relatively large action feature value or an enhanced action feature value, among moving images represented by moving image data and outputs data representing the action digest moving image (stores the data in, for example, the digest DB 810). For example, the digest generation unit 800 may form, from recording data, an answer digest moving image formed by an answer scene to each of one or more questions for which digest generation is designated in advance and store data of the formed answer digest moving image in the digest DB 810. The digest generation unit 800 may form, from recording data, an action digest moving image formed by a main action characteristics scene in estimating psychological characteristics and store data of the formed action digest moving image in the digest DB 810.

As explained above, data of a digest moving image for checking main points of an automatically performed interview is automatically formed and stored. This is convenient for the administrator 151 to check the main points and check appropriateness of an estimated psychological characteristics later.

### Fourth Embodiment

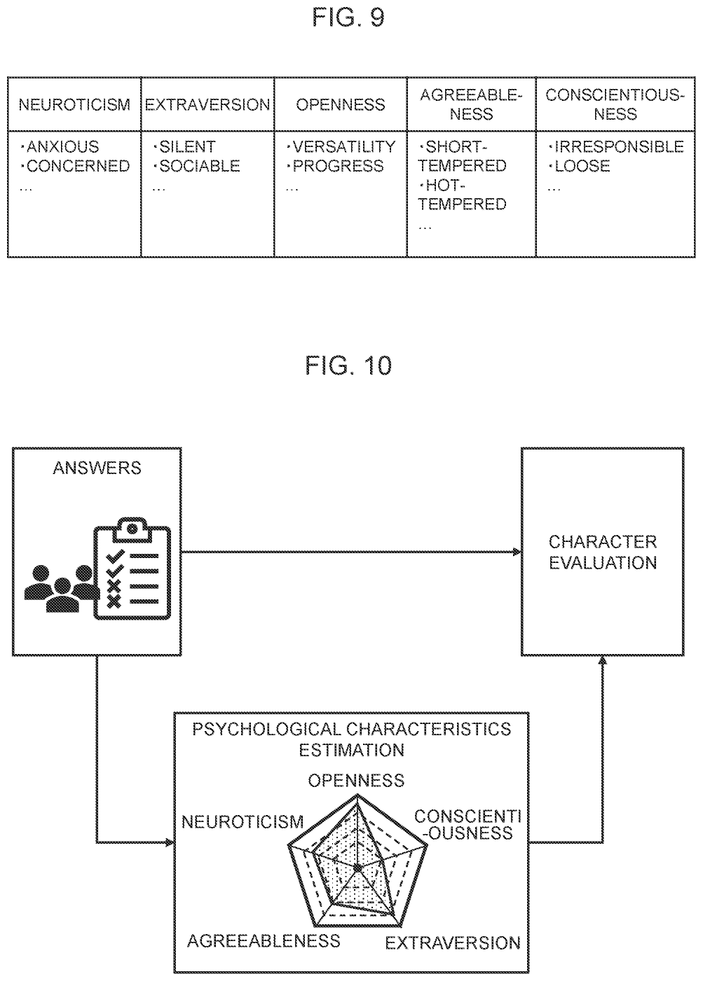

FIG. 9 illustrates an example of a keyword table according to a fourth embodiment.

A plurality of questions may include a question belonging to a psychological characteristics component. The “question belonging to a psychological characteristics component” means, for example, a question including a keyword belonging to the psychological characteristics component. Specifically, for example, as illustrated in FIG. 9, components such as neuroticism, openness, conscientiousness, extraversion, and agreeableness may be adopted as a plurality of psychological characteristics components forming psychological characteristics. One or more keywords of the question may be correlated with each of the psychological characteristics components.

A keyword table in which keywords are registered for each of psychological characteristics components, that is, a keyword table exemplified in FIG. 9 may be stored in, for example, the estimation DB 240 in advance. The keyword table may be an example of data representing keywords concerning psychological characteristics. In estimating psychological characteristics of the subject 101, the psychological characteristics estimation unit 213 may set the weight of a question including a keyword concerning the psychological characteristics relatively higher than the weight a question not including a keyword concerning the psychological characteristics. For example, to estimate psychological characteristics, the psychological characteristics estimation unit 213 may use an action feature value generated from related action data relating to an answer to a question including a keyword concerning the psychological characteristics and may not use an action feature value generated from related action data relating to an answer to a question not including a keyword concerning the psychological characteristics. Consequently, it is expected to accurately estimate psychological characteristics.

The several embodiments are explained above. However, the embodiments are exemplifications for explanation of the present invention and are not meant to limit the scope of the present invention to only these embodiments. The present invention can also be executed in other various forms.

For example, any two or more embodiments among the plurality of embodiments explained above can be combined.

In all the embodiments, by generating an action feature value from related action data of the subject 101 that changes in a limited time of an interview or the like and estimating psychological characteristics based on the generated action feature value, it is possible to implement automation of objective and accurate psychological characteristics estimation in a limited time.

In at least one of the first to fourth embodiments, a practical application exemplified in FIG. 10 may be adopted. That is, a character evaluation system may be present. The character evaluation system performs character evaluation (for example, determination of whether to hire or not) of a subject based on answer data of the subject and estimated psychological characteristics data of the subject. The character evaluation system may be a function in the character traits estimation system 100 or may be a function outside the character traits estimation system 100 (for example, a physical computer system or a logical computer system such as a cloud computing service). The character traits estimation system 100 may extract, for each of subjects, related action data for each of answers to questions from measurement data and output, to the character evaluation system, answer data representing the answers to the questions and estimated psychological characteristics data representing psychological characteristics estimated based on the related action data for each of the answers. With such a practical application, it is possible to improve, with technical means of the character traits estimation system 100, possibility of implementing automation of character evaluation for the subjects.

1. A character traits estimation system comprising:
an interface apparatus coupled to a subject apparatus that is an apparatus including one or a plurality of sensors; and
an arithmetic apparatus coupled to the interface apparatus, wherein
the arithmetic apparatus provides, to the subject apparatus, provision information including inducement information for inducing a subject to take an action for a purpose different from psychological characteristics estimation,
the arithmetic apparatus receives, from the subject apparatus, through the interface apparatus, measurement data relating to the action taken by the subject being induced by the provided inducement information, the measurement data being based on measurement by the one or the plurality of sensors,
the arithmetic apparatus specifies subject intention data and related action data based on the measurement data,
the action induced by the inducement information includes designation of a subject intention and a related action that is all or a part of actions excluding the designation of the subject intention,
the subject intention data is data representing the designated subject intention,
the related action data is data representing a related action,
the arithmetic apparatus calculates one or a plurality of action feature values based on related action data for each of one or a plurality of related actions and estimates psychological characteristics of the subject based on the one or the plurality of action feature values,
the arithmetic apparatus outputs estimated psychological characteristics data that is data representing the estimated psychological characteristics, and
each of one or more action feature values used to estimate the psychological characteristics of the subject is adjusted information on at least a part of the provided provision information and/or the action feature value enhanced according to an elapsed time.

2. The character traits estimation system according to claim 1, wherein the arithmetic apparatus
enhances, concerning each of the one or more action feature values, the action feature value according to the elapsed time and
estimates the psychological characteristics of the subject based on one or a plurality of action feature values including the one or more action feature values respectively enhanced.

3. The character traits estimation system according to claim 2, wherein
the arithmetic apparatus estimates, using a first estimation model, at least one psychological characteristics component among one or more psychological characteristics components of the psychological characteristics of the subject,
the first estimation model includes a multiple regression model for each elapsed time, and
the multiple regression model for each elapsed time includes:
n explanatory variables (n is an integer equal to or larger than 1) corresponding to n action feature values in a one-to-one relation; and
a weighting coefficient decided by the elapsed time for each of the n explanatory variables.

4. The character traits estimation system according to claim 3, wherein
for at least one psychological characteristics component of the one or more psychological characteristics components of the psychological characteristics of the subject, the arithmetic apparatus
selects, one estimation model of the first estimation model and a second estimation model based on a model selection policy including an arithmetic load of the arithmetic apparatus and a threshold of the arithmetic load, and
estimates the psychological characteristics component using the selected estimation model,
the second estimation model is a multiple regression model including n multiple regression models (n is an integer equal to or larger than 1) corresponding to the n action feature values in a one-to-one relation, and
for each of the n multiple regression models, the multiple regression model includes:
m weighting coefficients corresponding to, in a one-to-one relation, m time slots (m is an integer equal to or larger than 2) forming a time; and
an explanatory variable that is an action feature value corresponding to the multiple regression model for each of the m weighting coefficients.

5. The character traits estimation system according to claim 2, wherein
the arithmetic apparatus estimates, using a multiple regression model, at least one psychological characteristics component among one or more psychological characteristics components of the psychological characteristics of the subject,
for each of the one or more psychological characteristics components, the multiple regression model includes n multiple regression models (n is an integer equal to or larger than 1) corresponding to n action feature values in a one-to-one relation, and
for each of the n multiple regression models, the multiple regression model includes:
m weighting coefficients corresponding to, in a one-to-one relation, m time slots (m is an integer equal to or larger than 2) forming a time; and
an explanatory variable that is an action feature value corresponding to the multiple regression model for each of the m weighting coefficients.

6. The character traits estimation system according to claim 1, wherein
the one or the plurality of sensors includes a camera,
the measurement data includes moving image data that is data representing a moving image of the subject captured by the camera, and
the arithmetic apparatus specifies, based on the moving image data, related action data for each of one or a plurality of related actions.

7. The character traits estimation system according to claim 6, wherein
as the related action data, there is vital data specified, for the subject appearing in a moving image represented by the moving image data, from the moving image, and
the adjusted information on at least a part of the provision information is information in which both of luminance of content displayed on the subject apparatus and luminance of a background of the content are adjusted.

8. The character traits estimation system according to claim 6, wherein the arithmetic apparatus acquires an action digest moving image that is a moving image in a time period relating to a relatively large action feature value or an enhanced action feature value among moving images represented by the moving image data and outputs data representing the action digest moving image.

9. The character traits estimation system according to claim 6, wherein the related action data specified based on the moving image data represents at least one of a motion of a head of the subject, a facial expression of the subject, an eyeball motion of the subject, a posture of the subject, a body motion of the subject, sound of utterance of the subject, a vital sign of the subject, a time required for a response by the subject, and operation of the subject apparatus by the subject.

10. The character traits estimation system according to claim 1, wherein
the inducement information includes information representing a guide for the subject, and
the related action data includes data representing an action by the guided subject.

11. The character traits estimation system according to claim 1, wherein
the provision information includes information representing one or a plurality of questions to the subject, and
the arithmetic apparatus notifies a limit time for an answer to the one or the plurality of questions to the subject.

12. The character traits estimation system according to claim 1, wherein
the provision information includes information representing a plurality of questions to the subject,
each of the plurality of questions is classified into a group corresponding to an attribute of the question among a plurality of groups,
the subject intention data includes, for each of the plurality of questions, data representing an answer to the question, and
the arithmetic apparatus classifies, for each of the plurality of questions, related action data relating to an answer to the question into a group to which the question belongs, calculates, for each of the plurality of groups, an action feature value based on the related action data classified into the group, and estimates the psychological characteristics of the subject based on the action feature value calculated for each of the plurality of groups.

13. The character traits estimation system according to claim 1, wherein
the provision information includes information representing one or a plurality of questions to the subject, and
the arithmetic apparatus outputs answer data representing an answer to the one or the plurality of questions and the estimated psychological characteristics data to a function of evaluating a character based on the answer data and the psychological characteristics data.

14. A character traits estimation method comprising:
providing, to a subject apparatus that is an apparatus including one or a plurality of sensors, provision information including inducement information for inducing a subject to take an action for a purpose different from psychological characteristics estimation;
receiving, from the subject apparatus, measurement data relating to the action taken by the subject being induced by the provided inducement information, the measurement data being based on measurement by the one or the plurality of sensors;
the computer specifying subject intention data and related action data based on the measurement data,
the action induced by the inducement information including designation of a subject intention and a related action that is all or a part of actions excluding the designation of the subject intention,
the subject intention data being data representing the designated subject intention,
the related action data being data representing a related action;
calculating one or a plurality of action feature values based on related action data for each of one or a plurality of related actions and estimating psychological characteristics of the subject based on the one or the plurality of action feature values,
each of one or more action feature values used to estimate the psychological characteristics of the subject being adjusted information on at least a part of the provided provision information and/or the action feature value enhanced according to an elapsed time; and
outputting estimated psychological characteristics data that is data representing the estimated psychological characteristics.

15. A recording medium recording a computer program for causing a computer to execute:
providing, to a subject apparatus that is an apparatus including one or a plurality of sensors, provision information including inducement information for inducing a subject to take an action for a purpose different from psychological characteristics estimation;
receiving, from the subject apparatus, measurement data relating to the action taken by the subject being induced by the provided inducement information, the measurement data being based on measurement by the one or the plurality of sensors;
specifying subject intention data and related action data based on the measurement data,
the action induced by the inducement information including designation of a subject intention and a related action that is all or a part of actions excluding the designation of the subject intention,
the subject intention data being data representing the designated subject intention,
the related action data being data representing a related action;
calculating one or a plurality of action feature values based on related action data for each of one or a plurality of related actions and estimating psychological characteristics of the subject based on the one or the plurality of action feature values,
each of one or more action feature values used to estimate the psychological characteristics of the subject being adjusted information on at least a part of the provided provision information and/or the action feature value enhanced according to an elapsed time; and
outputting estimated psychological characteristics data that is data representing the estimated psychological characteristics.
